(19) United States
(12) Patent Application Publication
(10) Pub. No.: US 2006/0268307 A1
(43) Pub. Date: Nov. 30, 2006

(54) Method of evading printing errors and printing system therefor

(75) Inventors: Don-seon Lee, Yongin-si (KR); Jae-pyoung Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/432,413

(22) Filed: May 12, 2006

(30) Foreign Application Priority Data
May 27, 2005 (KR) 2005-45052

(51) Int. Cl. G06K 15/00; G06F 3/12

(52) U.S. Cl. 358/1.13; 358/1.14

(57) ABSTRACT

A method of evading printing errors for use with a printing system having a language monitor receiving commands generated by a driver unit from a spooler to transmit the commands to a frame buffer, including detecting errors in an operation of the language monitor, displaying that the errors are detected, and canceling a function of the language monitor based on a selection of a user.

### CROSS-REFERENCE TO RELATED APPLICATION

This application claims the benefit of Korean Application No. 2005-45052, filed May 27, 2005, in the Korean Intellectual Property Office, the disclosure of which is incorporated herein by reference.

### BACKGROUND OF THE INVENTION

1. Field of the Invention

Aspects of the present invention relates to a method of evading printing errors and a printing system therefor, and, more particularly, to a method of evading printing errors by canceling a function of a language monitor, and a printing system therefor.

2. Description of the Related Art

FIG. 1 illustrates an operation principle of a printing system employing a conventional image forming apparatus.

As shown in FIG. 1, the conventional printing system includes an engine unit 70, and an image forming apparatus having a graphics device interface (GDI) unit 10, a driver unit 20, a spooler 30, a language monitor 40, a frame buffer 50, and a port monitor 60.

Windows for transmitting objects to the image forming apparatus according to printing commands from application programs are built in the GDI unit 10. The driver unit 20 receives the objects from the GDI unit 10 and then generates commands accordingly so that the frame buffer 50 makes the objects into bitmaps.

Windows for transmitting the commands from the driver unit 20 to the language monitor 40 are built in the spooler 30. The language monitor 40 transmits the commands received from the spooler 30 to the frame buffer 50.

The frame buffer 50 converts the commands transmitted from the language monitor 40 into bitmaps so that the image forming apparatus may form images.

The operation of the conventional image forming apparatus will be described with reference to FIG. 1. When printing commands are transmitted from a user, an application program (not shown) calls the GDI unit 10, and the GDI unit 10 then creates the objects corresponding to the above-described printing commands. Then, the GDI unit 10 transmits the objects to the driver unit 20.

After receiving the objects from the GDI unit 10, the driver unit 20 generates commands so that the frame buffer 50 converts the objects into the bitmaps, and transmits the generated commands to the spooler 30. The spooler 30 receives the commands from the driver unit 20 and then transmits the commands to the language monitor 40.

Next, the language monitor 40 transmits the commands received from the spooler 30 to the frame buffer 50. The frame buffer 50 converts the commands transmitted from the language monitor 40 into the bitmaps that the image forming apparatus interprets to form images, and then transmits the bitmapped commands to the language monitor 40. The language monitor 40 transmits the above-described bitmapped commands through the port monitor 60 to the engine unit 70. After receiving the bitmapped commands, the engine unit 70 performs printing in accordance with the commands.

The above-described language monitor 40 receives the commands generated by the driver unit 20 from the spooler 30 to transmit the commands to the frame buffer 50. However, the language monitor 40 has been found to not be essential in printing. This is due to the fact that the spooler 30 may directly transmit the commands of the driver unit 20 to the frame buffer 50 itself. However, it is possible to show a state of the image forming apparatus by using the language monitor 40. However, the printer may abnormally operate due to errors of the language monitor 40 during the use of the image forming apparatus. In such a case, the user has to re-install the printer.

That is, according to the conventional art, when something is wrong with the language monitor 40 that is not directly related to the printing but serves as an additional factor that improves a performance of the image forming apparatus or shows the state of the image forming apparatus, the printing has to be stopped and the image forming apparatus has to be re-installed. This causes inconvenience and a waste of time.

### SUMMARY OF THE INVENTION

Aspects of the present invention have been developed in order to solve the above and/or other problems associated with the related art. A feature of the present invention is to provide a method of evading printing errors in a language monitor, and a printing system therefor.

In order to achieve a feature of the present invention, a method of evading printing errors, comprises detecting errors in an operation of a language monitor receiving commands generated by a driver unit of an image forming apparatus from a spooler to transmit the commands to a frame buffer, displaying that the errors are detected, and canceling a function of the language monitor based on a selection of a user. On the other hand, according to the present invention a printing system comprises a driver unit which generates commands to print data, a spooler which provides an intermediate path of the generated command, and a language monitor which receives the command through the spooler to transmit to a frame buffer. The driver unit detects errors in an operation of the language monitor and cancels a function of the language monitor when printing in a state in which the function of the language monitor is canceled is selected after the operation errors detected.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the operation principle of a printing system employing a conventional image forming apparatus;

FIG. 2 illustrates the structure of a printing system employing a image forming apparatus according to an embodiment of the present invention;

FIG. 3 illustrates a dialog window provided to a user according to an embodiment of the present invention; and

FIG. 4 is a flowchart illustrating a principle of realizing a method of evading printing errors.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 illustrates the structure of a printing system employing an image forming apparatus according to an embodiment of the present invention.

Referring to FIG. 2, a printing system according to an embodiment of the present invention includes an image forming apparatus and an engine unit 170. The image forming apparatus, which generates print data and transmits the data to the engine unit 170, includes a host computer. The engine unit 170, which prints the print data received from the image forming apparatus on a paper, includes a printer, a facsimile, and a multifunctional device.

The image forming apparatus includes a graphics device interface (GDI) unit 110, a driver unit 120, a spooler 130, a language monitor 140, a frame buffer 150, and a port monitor 160.

Windows for transmitting objects to the image forming apparatus according to printing commands from application programs are built in the GDI unit 110.

The driver unit 120 receives the objects from the GDI unit 110, and then generates commands to cause the frame buffer 150 to convert the objects into bitmaps.

Windows for transmitting the commands from the driver unit 120 to the language monitor 140 are also built in the spooler 130. The language monitor 140 transmits the commands received from the spooler 130 to the frame buffer 150.

The frame buffer 150 converts the commands that are transmitted from the language monitor 140 into bitmaps so that the engine unit 170 can form images.

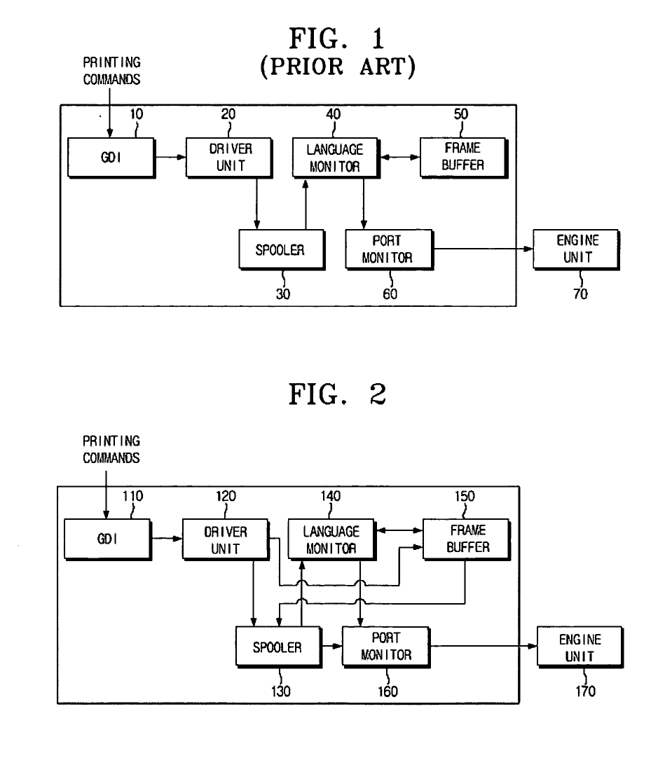

The operational principles of the present invention are substantially similar as those which apply to the conventional image forming apparatus illustrated in FIG. 1 when the language monitor 140 normally operates without errors. Differences in the operational principles between the present invention and the conventional art when errors are generated in the language monitor 140 will be described hereinafter.

First, the GDI unit 110 that receives printing commands from an application program (not shown) transmits the objects corresponding to the printing commands to the driver unit 120. After receiving the objects, the driver unit 120 generates commands accordingly to cause the frame buffer 150 to convert the objects into bitmaps.

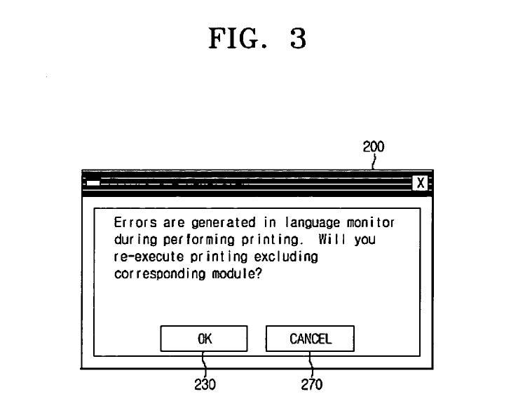

The generated commands are then transmitted to the language monitor 140 through the spooler 130. The driver unit 120 determines a state of the language monitor 140 immediately before the commands are transmitted. Where the driver unit 120 determines that the language monitor 140 cannot normally operate due to errors, the image forming apparatus asks a user whether to continuously perform printing through a dialog window. This will be explained in more detail with reference to FIG. 3

FIG. 3 illustrates the dialog window according to an embodiment of the present invention.

Here, if the image forming apparatus is a host computer, and a dialog window 200 indicating an error occurrence is displayed on a monitor screen (not shown), when the user selects an OK button 230 through a mouse, or other input device of the host computer, the GDI unit 110 receives the selection command of the user and transmits the selection command to the driver unit 120.

The driver unit 120 receives the selection command and, accordingly, cancels a function of the language monitor 140. The driver unit 140 then directly transmits the above-described printing commands to the frame buffer 150, and the frame buffer 150 transmits a bitmapped image to the spooler 130. After the spooler 130 receives the bitmapped image, the spooler 130 transmits the bitmapped image to the engine unit 170 through the port monitor 160. Next, images in accordance with the printing commands are output from the engine unit 170.

When the user selects a cancel button 270 from the dialog window 200 through the mouse of the host computer (or some other input mechanism), the GDI unit 110 receives the cancel command of the user and transmits the cancel command to the driver unit 120.

The driver unit 120 that received the cancel command does not cancel the function of the language monitor 140 but, rather, cancels the printing work of the engine unit 170.

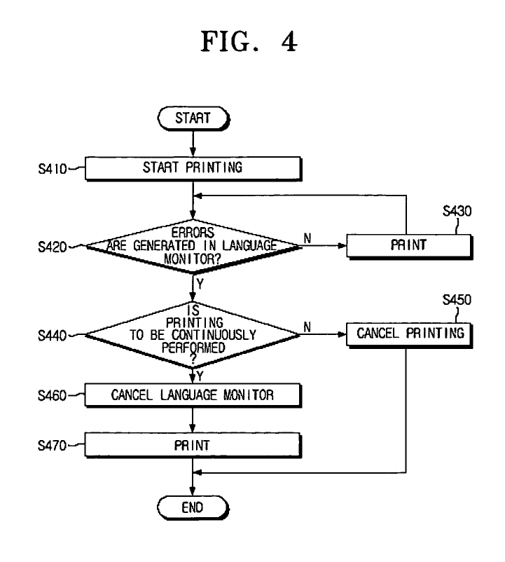

FIG. 4 is a flowchart illustrating a method of evading printing errors.

The operational principle of the method will also be described with reference to FIGS. 2 and 4. First, when the printing work starts (S410), the driver unit 120 periodically checks whether errors in an operation of the language monitor 140 are generated (S420).

Once the driver unit 120 determines that the errors in the operation of the language monitor 140 are not generated, the printing work continues (S430). When the driver unit 120 determines that the errors in the operation of the language monitor 140 are generated, the dialog window 200 illustrated in FIG. 3 is displayed on the monitor of the image forming apparatus such as the host computer to let a user select whether to continuously perform the printing after a cancellation of the function of the language monitor 140 (S440).

If the user selects the cancel button 270 to cancel the printing, the driver unit 120 cancels the printing of the engine unit 170 (S450).

However, if the user selects the OK button 230 from the dialog window 200 to continuously perform the printing, the driver unit 120 cancels the function of the language monitor 140 (S460) and directly transmits the printing commands to the frame buffer 150 so that the printing is continuously performed (S470).

As is described above, according to aspects of the present invention, when the language monitor, which is a module to improve the performance or function of the image forming apparatus, and which is not related to printing, does not normally operate, printing operations may be performed without the use of the language monitor. As a result, it may not be necessary for the user to cancel the printing work, to re-install a image forming apparatus driver, or to re-execute his/her operating system upon an error in the language monitor.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of evading printing errors, comprising:
detecting errors in an operation of a language monitor receiving commands generated by a driver unit of an image forming apparatus from a spooler to transmit the commands to a frame buffer;
displaying that the errors are detected; and
canceling a function of the language monitor based on a selection of a user.

2. The method according to claim 1, wherein the displaying comprises displaying that the errors are detected when the errors are detected.

3. The method as claimed in claim 1, further comprising performing printing operations with the function of the language monitor being canceled.

4. The method as claimed in claim 3, further comprising canceling the printing operations when errors in the operation of the language monitor are detected and the user selects not to cancel the function of the language monitor.

5. The method as claimed in claim 1, further comprising continuously performing the printing through the function of the language monitor when the errors in the operation of the language monitor are not detected.

6. The method as claimed in claim 1, further comprising periodically re-detecting the errors in the operation of the language monitor when the errors are not detected.

7. The method as claimed in claim 1, wherein the displaying is performed by a display unit on the image forming apparatus.

8. A printing system, comprising
a driver unit which generates commands to print data;
a spooler which provides an intermediate path of the generated command; and
a language monitor which receives the command through the spooler to transmit to a frame buffer,
wherein the driver unit detects errors in an operation of the language monitor and cancels a function of the language monitor when printing in a state in which the function of the language monitor is canceled is selected after the operation errors detected.

9. The printing system as claimed in claim 8, further comprising an engine unit to perform the printing in the state in which the function of the language monitor is canceled.

10. The printing system as claimed in claim 9, wherein the driver unit cancels the printing when the printing in the state in which the function of the language monitor is canceled is not selected.

11. The printing system as claimed in claim 10, wherein the driver unit continuously performs the printing without canceling the function of the language monitor when the errors are not detected.

12. The printing system as claimed in claim 8, wherein the driver unit re-detects the errors in the language monitor after a lapse of a predetermined time when the errors are not detected.

13. A method of evading printing errors during printing operations for use with an image forming apparatus, comprising:
detecting errors in an operation of a language monitor receiving commands generated by a driver unit of the image forming apparatus from a spooler to transmit the commands to a frame buffer;
displaying that the errors are detected and providing a user an option of continuing or canceling the printing operations;
if the option of continuing the printing operations is selected, canceling a function of the language monitor based on a selection of a user and continuing the printing operations; and
if the option of canceling the printing operations is selected, canceling the printing operations.

14. The method according to claim 13, further comprising re-detecting the errors in the operation of the language monitor after a lapse of a predetermined time when the errors are not detected.

15. An image forming apparatus, comprising:
a graphics device interface (GDI) unit including windows for transmitting objects to the image forming apparatus during a printing operation;
a driver unit to receive the objects from the GDI unit, and to generate commands for converting the objects into bitmaps;
a frame buffer to convert the commands into bitmaps with which the image forming apparatus forms images; and
a language monitor to transmit the commands from the driver unit via a spooler to the frame buffer, wherein, if the language monitor operates improperly during a printing operation, either the printing operation is cancelled or the commands are transmitted from the spooler to the frame buffer directly.
